(19) United States
(12) Patent Application Publication
(10) Pub. No.: US 2011/0290046 A1
(43) Pub. Date: Dec. 1, 2011

(54) ACTUATION DEVICE OF A ROTATING, SHIFTABLE MECHANICAL CONNECTION

(75) Inventor: Oliver GLOGE, Friedrichshafen (DE)

(73) Assignee: ZF FRIEDRICHSHAFEN AG, Friedrichshafen (DE)

(21) Appl. No.: 13/051,287

(22) Filed: Mar. 18, 2011

(30) Foreign Application Priority Data
May 31, 2010 (DE) 10 2010 029 488.8

(51) Int. Cl. F16H 25/08

(52) U.S. Cl. 74/25

(57) ABSTRACT

An actuating device for a rotatable, shiftable mechanical connection. The connection comprises first and second connection portions (2, 3) which each have teeth (4) and an actuator (11) for causing relative axial movement of the first and the second connection portions (2, 3) for engaging and retaining the connection in an engaged position. A radially adjustable axial bearing (21) is formed between a rotatable axially movable piston (8), on which one of the first and the second connection portions (2 or 3) is arranged, and a fixed machine component (9). The axial bearing (21) has bearing elements (25) which can be radially displaced, by actuation of the actuator (11), such that the piston (8) can be moved in an axial direction along a defined engagement travel path (26) into the engaged position and, when in an end position of the actuator (11), the piston (8) is retained within the engaged position.

This application claims priority from German patent application serial no. 10 2010 029 488.8 filed May 31, 2010.

### FIELD OF THE INVENTION

The invention concerns an actuating device for a rotating.

### BACKGROUND OF THE INVENTION

As is known, a rotating, shiftable mechanical connection with a conventional claw pair having abutment teeth is often difficult to separate because of core stresses and pressures. This problem occurs particularly in claw clutches in drivetrains of vehicles when a torque is transmitted. It can be helpful to open out the abutment teeth by giving them tooth flanks which are inclined relative to a rotation axis of the claw pair. However, this substantially reduces the otherwise usual self-locking effect at the tooth flanks, which has to be overcome when the connection is separated, and thus also reduces the mechanical efficiency of the connection. Consequently, larger holding forces are needed.

In the case of pressure-medium-actuated claw clutches, in particular hydraulically actuated ones, the necessary hydraulic forces that must be applied, for holding the clutch engaged, can increase markedly. When particularly large torques are to be transmitted, a hydraulic pressure available may no longer be sufficient to hold the claws coupled together. It therefore seems appropriate to hold a claw pair with inclined tooth flanks together in the engaged condition with the help of detent or locking means, in order to avoid the need to produce permanently large hydraulic or pressure-medium-related holding forces.

From DE 601 30 049 T2, such a claw clutch with inclined tooth flanks is known, in which means are provided for blocking the claws in an engaged position. One half of the claw clutch is arranged so that it can rotate on an output shaft. On its circumference, it has teeth, by means of which it engages with a gearwheel, which is driven by an input shaft of a drivetrain of a tractor. The claw clutch serves to engage a front wheel drive when necessary. The other half of the clutch is in the form of a collar element which is also arranged on the output shaft, but rotationally fixed although axially movable on it.

Each half of the clutch has claw teeth with angled flanks, by virtue of which the drive input can be transmitted to the output shaft for the front wheel drive when the clutch is engaged. The collar is prestressed in the closing direction by a spring, so that the halves of the clutch are normally in the engaged position. In an axial bore of the output shaft is arranged an axially movable actuator in the form of a control piston, which is also prestressed in the closing direction within the bore by a spring.

The piston and the collar can be acted upon, in the opening direction, by a pressure medium via a diametral axial bore and a transverse bore. The control piston co-operates with a radial bolt by means of a conical attachment which tapers down to a pin. In the engaged condition, the bolt rests in contact on the circumference of a shaft of the control piston. The bolt projects radially and is seated in a recess of the collar, so blocking it against any backward movement in the opening direction.

When the control piston is pushed hydraulically in the opening direction against the prestressing spring, the bolt follows along the conical attachment and moves radially inward so that the collar is released and the tooth connection moves out of engagement as soon as the hydraulic action, upon the collar, overcomes the spring load acting in the closing direction.

Since the claw tooth flanks are only inclined at a shallow angle, when a hydraulic action in the opening direction begins, the connection is not released immediately but after a short delay. On the other hand, however, an excessive delay due to self-locking, as can occur in the case of conventional abutment teeth with parallel tooth flanks, is reliably prevented. In this way, jerky load reversal reactions in the drivetrain, when the front wheel drive is engaged and disengaged, are at least reduced.

The known claw connection is engaged by spring means, blocked in the engaged position by a spring-loaded actuator that co-operates with a radial bolt, and disengaged by the action of the pressure of a hydraulic medium. Compared with a connection engaged by means of a pressure medium, greater complexity and cost are entailed for the spring means. A further disadvantage is that the radial bolt acts upon the actuator at a point, whereby increased wear and the risk that the detaining mechanism may twist or tilt can arise. Moreover, the actuator and the one-sided radial bolt are part of the rotating system, whereby undesired centrifugal forces with unfavorable effects on the mounting of the shaft so acted upon can occur.

### SUMMARY OF THE INVENTION

Against this background, the purpose of the present invention is to provide an improved actuating device for a rotating, shiftable mechanical connection having teeth with inclined tooth flanks, which is of simple design, with low wear, and reliable in operation.

This objective is achieved by the characteristics specified in the principal claim, while advantageous design features and further developments of the invention emerge from the subordinate claims.

The invention is based on the realization that a rotating claw connection transmitting torque, whose claw teeth are formed with included tooth flanks in order to ensure easy separation, can be engaged and retained in the engaged position with the help of an adjustable bearing mechanism by means of which an axial bearing can be operated with varying diameters.

Accordingly, the invention starts from an actuating device for a rotating, shiftable mechanical connection, in particular a claw clutch, having a first and a second connection portion comprising teeth whose tooth flanks are inclined relative to a rotation axis, with an actuator by which the connection can be engaged by virtue of an axial relative movement of the said connection portions and with means for holding the connection in an engaged position.

To achieve the stated objective, the invention provides that between a rotating, axially movable piston on which one of the connection portions is arranged, and a fixed machine component, a radially adjustable axial bearing is formed, the said axial bearing comprising bearing elements which can be moved, in the radial direction, by actuating the actuator such that, by virtue of a radial displacement of the axial bearing, the piston can be moved through a defined engagement path, in the axial direction, into the engaged position and, in an end position of the actuator, the piston is retained in the engaged position.

This arrangement enables comfortable actuation of a claw clutch with which the claw connection can, in particular, be engaged dynamically by the action of a pressure medium and, by means of a mechanical mounting by an axial bearing, can be held securely and mounted against a fixed support with little wear and easy operability.

In a preferred embodiment of the actuating device, the axial bearing is in the form of a ball bearing in which the bearing elements in the form of balls form a ring of balls with variable diameter in an variable bearing space. For example, when the diameter is at its smallest, the balls are in direct contact with one another, whereas as the diameter increases, intermediate spaces are formed around the circumference between the balls.

The axial bearing can be actuated by a control cylinder which, to save space, can be inserted in an axial bore of the machine component. The actuator or control cylinder can preferably be actuated hydraulically. Basically, however, some other actuation means is possible, for example mechanically, pneumatically or electrically.

Advantageously, in the area of the axial bearing, the actuator has a conical guiding section whose surface contour is followed by the bearing elements when the actuator moves axially. The said guiding section is joined to a cylindrical shaft facing toward the machine component, against which the bearing elements rest in the engaged and retained position.

Advantageously, the dimensions of the guiding section of the actuator, an axial adjustment path of the actuator and the size of the bearing elements are matched to one another in such manner that the engagement travel, when the piston is displaced, corresponds to a dimension or a diameter of the bearing elements so that, in the end position of the actuator, the bearing elements are held between a front end of the piston and a facing end of the machine component, and act as a supporting bearing between the rotating piston in its engaged and retained position and the fixed machine component.

Accordingly, the geometrical structure of the individual co-operating surfaces, in particular the conical guiding section of the actuator and the conical recesses of the end sections on the piston and the machine component, ensure that due to the movement of the actuator, the bearing balls are pressed against the piston so that the piston is pushed through the necessary displacement or engagement distance.

Likewise, the geometric structure of the said surfaces ensures that in the end position of the actuator, the bearing balls move between the supporting machine component and the piston and there maintain the distance to be held, i.e., retain the piston in the engaged position so that the rotating piston is supported against the fixed machine component or housing.

When the connection is in its engaged condition, the actuator is in its end position and the bearing balls form a ring with circumferential spaces between them around the shaft of the actuator. In the disengaged condition, the actuator is axially retracted and the bearing balls form a ring of smaller diameter around the periphery of the guiding section of the actuator so that the piston can move back, in the direction opposite to its engagement direction, until its rear end face is resting against the machine component, or nearly against it, whereby a small gap can remain so that, in the disengaged position as well, the piston is preferably supported by the balls against the machine component. Thus, depending on the position to which the actuator is pushed, the axial bearing has different diameters.

Together with the surface of the actuator and a wall section that surrounds the piston and the machine component radially on the outside, the said end sections delimit the variable bearing space of the bearing elements of the axial bearing. Thus, the axial bearing is limited at its maximum radial size on the radially outer diameter of the machine component or piston, and can therefore be relatively simply integrated into an existing design of a clutch arrangement.

The end section of the piston can inexpensively be connected integrally to the piston itself. In a manner advantageous from the standpoint of production technology, the end section of the machine component can be made as a separate component connected to the fixed machine component, the latter formed for example as a housing.

Furthermore, it can be provided that at its front end facing toward the piston, the actuator has a cylindrical pin, connected to the conical guiding section, which can fit into the adjacent central recess of the piston. This ensures properly centered guiding of the actuator and accurate adjustability of the axial bearing.

### BRIEF DESCRIPTION OF THE DRAWINGS

To clarify the invention, the description of a drawing of an example embodiment is attached, showing:

FIG. 1: Representation of a claw clutch with an adjustable axial bearing in a disengaged condition, shown in longitudinal section,

FIG. 2: The claw clutch, according to FIG. 1, in an engaged condition, and

FIG. 3: A schematic, simplified representation of abutment teeth and teeth of a claw clutch, not engaged, for comparison.

### DETAILED DESCRIPTION OF THE PREFERRED EMBODIMENTS

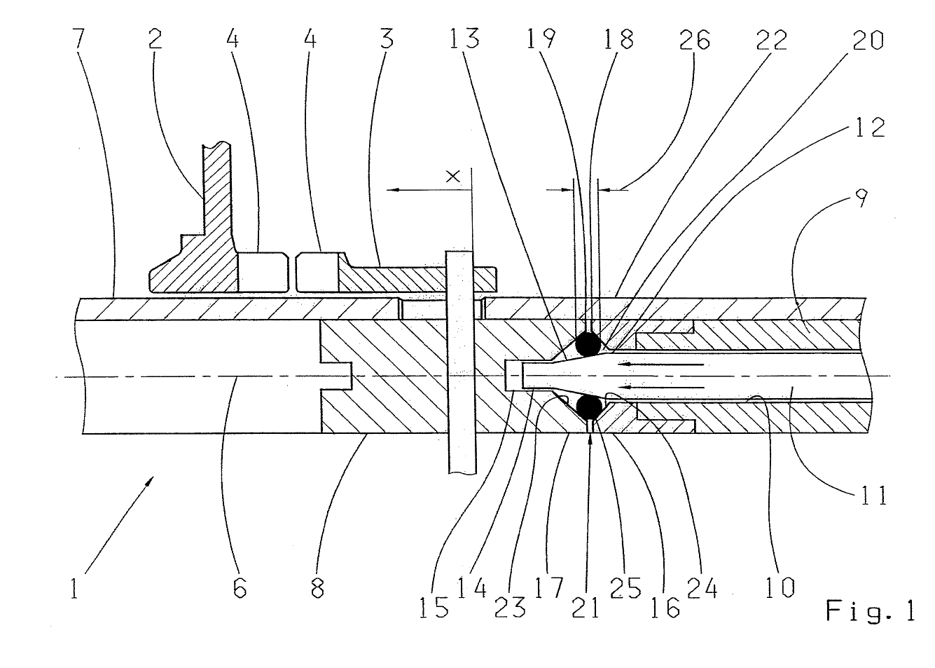

Thus, as shown in FIG. 1, a rotating mechanical connection, in the form of a claw clutch for example as can be built into a drivetrain of a vehicle, comprises a first connection portion 2 and a second connection portion 3. In each case, the connection portions 2, 3 have an array of teeth 4 which are not mutually engaged, whose tooth flanks 5 are inclined relative to a rotation axis 6. The tooth arrays 4 can be brought into form-locked engagement by relative axial movement of the connection portions 2, 3, in particular by displacing one of the connection portions 2, 3, to form a connection for torque transmission.

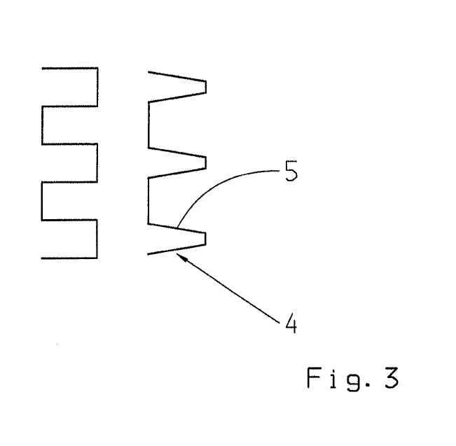

For the sake of clarity, FIG. 3 shows a projection of a tooth array 4 with inclined tooth flanks 5 (on the right in the figure), compared with a conventional abutment tooth array with parallel flanks (on the left).

The first connection portion 2 is arranged on a rotating component, for example a rotating shaft or a hollow shaft 7. The second connection portion 3 is connected to a rotating piston 8, independently of the first connection portion 2. The piston 8 is fitted to move axially within the diameter of the shaft 7.

A fixed cylindrical machine component 9, for example in the form of a housing, is arranged coaxially close to the piston 8. In an axial bore 10 of this housing 9, an actuator 11, in the form of a control cylinder, is inserted and able to move axially. The actuator 11 has a shaft 12 that extends into the axial bore 10 and a guiding section 13 that conically tapers toward the piston 8, which projects out of the axial bore 10. At the end of the guiding section 13 is a pin 14 which projects coaxially into a corresponding, opposite recess 15 of the piston 8, which functions as a centering means and an end-stop for the actuator 11.

On their end faces close to one another, the piston 8 and the housing 9 have respective end sections 16, 17, which are conically recessed. Radially on the outside, the recesses 23, 24 respectively delimit annular surrounding front edges 18, 19. The outsides of the piston 8 and the housing 9 are surrounding by an overlapping wall section 22 which, for example, can be part of a tubular component or a hollow shaft. Radially on the inside, the recess 23 of the piston end section 17 borders on the centering recess 15. Radially on the inside the recess 24 of the actuator's end section 16 borders on the axial bore 10.

The recesses 23, 24 of the end sections 16, 17, together with the front edges 18, 19 and the surrounding wall section 22, on one side, and the surface of the actuator 11, on the other side, delimit a variable bearing space 20 for an axial bearing 21. The said bearing space 20 is in the shape of two truncated cones with their notional base surfaces facing one another, through which the actuator 11 projects in such manner that the said notional base surfaces are aligned with the front edges 18, 19. By virtue of the mobility of the piston 8, the separation of the base surfaces or front edges 18, 19 is variable.

The axial bearing 21 is in the form of a ball bearing. The bearing elements 25, in the form of balls, form a ring of balls around the circumference of the actuator. Depending on the axial position to which the actuator 11 has been pushed, the axial bearing 21 assumes different radial diameters. The number of balls 25 is limited by a minimum radial bearing diameter so that, when the front edges 18, 19 are almost in contact, which corresponds to a disengaged position of the clutch 1, the balls 25 are in contact with one another in a ring around the cone surface of the guiding section 13. On the other hand, when the actuator 11 is pushed in the engagement direction x, the ball ring spreads out whereby the front edges 18, 19 are pushed apart. The axial diameter of the bearing 21 is determined by the diameter of the balls 25. This is chosen such that the ball diameter corresponds to an engagement travel path 26 of the clutch 1.

The connection functions as follows:

FIG. 1 shows the disengaged clutch 1, i.e., with the connection portions 2, 3 separated. The actuator 11 is in a retracted position. The axial bearing 21 keeps the piston 8 apart relative to the housing 9 so that there is only a narrow annular gap between the front edges 18, 19 at the ends of the piston 8 and the housing 9. Basically, the actuator 11 could even be retracted far enough for the ends of the piston 8 and the housing 9 to be in contact, although this is regarded as less advantageous.

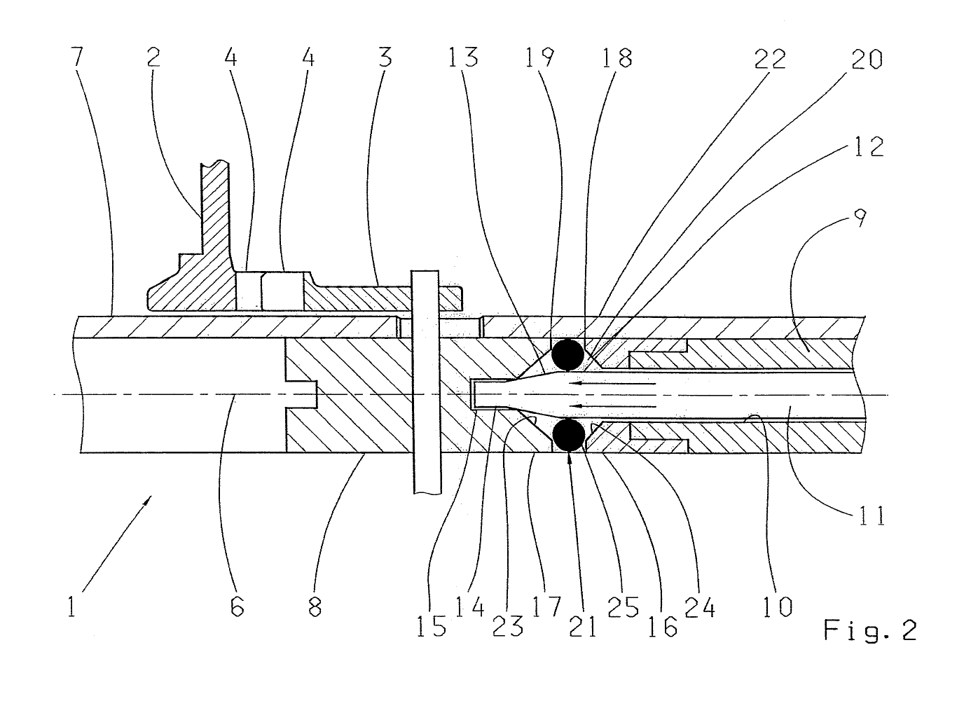

FIG. 2 shows the engaged clutch 1, i.e., with the connection portions 2, 3 mutually engaged. The engagement process occurs due to a pressure-medium-enforced displacement of the actuator 11 in the direction shown as x in FIG. 1. During this, the bearing balls 25 follow the widening conical contour of the guiding section 13 of the actuator 11 radially outward and are pressed, on one side, against the surface of the end section 16 of the fixed housing 9 and, on the other side, against the surface of the end section 17 of the moving piston 8. Consequently, the piston 8 is displaced in the x direction.

In an end position of the actuator 11, delimited by the bottom or end-stop of the centering recess 15, the bearing balls 25 have pushed between the front edges 18, 19 of the piston 8 and the housing 9. The displacement path corresponds to the diameter of the bearing balls 25 which, in turn, corresponds to the engagement travel 26 of the connection. The bearing balls 25 now rest against the cylindrical actuator shaft 12 which has in part emerged from the axial bore 10 of the housing 9 so that no resultant force is acting upon the actuator 11 in the direction opposite to the x direction. On the other hand, the bearing balls 25 support the rotating piston 8 against the fixed housing 9. Thus, the connection is held fixed so long as the actuator 11 is in its end position. The connection is released again by moving the actuator 11 axially backward, in a manner requiring no further description.

### LIST OF INDEXES

1 Claw clutch
2 Connection portion
3 Connection portion
4 Teeth
5 Tooth flank
6 Rotation axis
7 Shaft
8 Piston
9 Machine component
10 Axial bore
11 Actuator
12 Shaft
13 Guiding section
14 Pin
15 Recess
16 End section
17 End section
18 Front edge
19 Front edge
20 Bearing space
21 Axial bearing
22 Wall section
23 Recess
24 Recess
25 Bearing element
26 Engagement travel path
x Actuation direction

1-10. (canceled)

11. An actuating device for a rotatable, shiftable mechanical connection, the rotatable, shiftable mechanical connection comprising a first connection portion (2) and a second connection portion (3) each comprising teeth (4) whose tooth flanks (5) are inclined relative to a rotational axis (6), and an actuator (11) for causing relative axial movement of the first and the second connection portions (2, 3) with respect to one another for engaging the connection a means for retaining the connection in an engaged position,
wherein a radially adjustable axial bearing (21) is formed between a rotatable, axially movable piston (8), on which one of the first and the second connection portions (2 or 3) is arranged, and a fixed machine component (9), the axial bearing (21) has bearing elements (25) which can be displaced, in a radial direction, by actuation of the actuator (11) such that the piston (8) can be moved, by radial displacement of the axial bearing (21), in an axial direction along a defined engagement travel path (26) into the engaged position and, when in an end position of the actuator (11), the piston (8) is retained within the engaged position.

12. The actuating device according to claim 11, wherein, in an adjustable bearing space (20), the axial bearing (21) is in a form of a ball bearing and the bearing elements (25) form a ring of balls with variable radial diameter.

13. The actuating device according to claim 11, wherein the actuator (11) is a control cylinder which is inserted within an axial bore (10) of the machine component (9) and can move axially therein.

14. The actuating device according to claim 11, wherein the actuator (11) has a conical guiding section (13), in an area of the axial bearing (21), and the bearing elements (25) follow a surface contour of the guiding section (13) when the actuator (11) moves axially, and the guiding section (13) is connected to a cylindrical shaft (12) which faces toward the machine component (9) on which the bearing elements (25) rest in the engaged position.

15. The actuating device according to claim 11, wherein dimensions of the guiding section (13) of the actuator (11) and an axial control path of the actuator (11) and a size of the bearing elements (25) are matched to one another such that the engagement path (26), when the piston (8) is displaced, corresponds to a diameter of the bearing elements (25) so that, in the end position of the actuator (11), the bearing elements (25) are retained between an end face of the piston (8) and an opposite end face of the machine component (9), and in the engaged and retained position, the bearing elements (25) support the movable piston (8) against the fixed machine component (9).

16. The actuating device according to claim 11, wherein an end section (17), with a conical recess (23), is formed adjacent an end of the piston (8) facing toward the axial bearing (21) and is located between a central recess (15) of the piston (8) and an annular front edge (19) of the piston (8),
a corresponding end section (16), with a conical recess (24), is formed adjacent an end of the machine component (9) facing toward the axial bearing (21) and is located between the axial bore (10) of the machine component (9) and an annular front edge (18) of the machine component (9) facing toward the axial bearing (21), and
the end sections (16, 17) together with a surface of the actuator (11) and a wall section (22) that radially surrounds the piston (8) and the machine component (9) on an outside, delimit a variable bearing space (20) for the bearing elements (25) of the axial bearing (21).

17. The actuating device according to claim 16, wherein the end section (17) of the piston (8) is connected integrally to the piston (8).

18. The actuating device according to claim 16, wherein the end section (16) of the machine component (9) is connected to the machine component (9) as a separate component.

19. The actuating device according to claim 11, wherein the actuator (11) has a cylindrical pin (14), connected to the conical guiding section (13), at an end thereof facing toward the piston (8), and the cylindrical pin (14) can be held in an adjacent central recess (15) of the piston (8).

20. The actuating device according to claim 11, wherein the actuator (11) can be actuated one of hydraulically, mechanically, pneumatically, electrically and by a combination of hydraulically, mechanically, pneumatically and electrically.

21. The actuating device according to claim 11, wherein the rotatable, shiftable mechanical connection is a claw clutch (1).
